(19) United States
(12) Patent Application Publication
(10) Pub. No.: US 2013/0196803 A1
(43) Pub. Date: Aug. 1, 2013

(54) Toothless Link Chain with Asymmetric Link Plates

(71) Applicant: IWIS Motorsysteme GMBH & Co., KG, Munchen (DE)

(72) Inventors: Martin BODENSTEINER, Munchen (DE); Renzo PERISSINOTTO, Dachau (DE)

(73) Assignee: IWIS MOTORSYSTEME GMBH & CO., KG, Munchen (DE)

(21) Appl. No.: 13/753,991

(22) Filed: Jan. 30, 2013

(30) Foreign Application Priority Data
Jan. 31, 2012 (DE) 102012001809.6

(51) Int. Cl. F16H 7/06

(52) U.S. Cl. CPC F16H 7/06
USPC 474/140; 474/230

(57) ABSTRACT

The invention refers to a toothless link chain with alternating chain links, wherein inner and outer link plates of the chain links have a substantially identical height profile. The link plate backs of the inner or outer link plates, which are brought into contact with a guide rail, have an at least partial height offset to the link plate backs of the other link plates. A connecting line through the center points of the joint openings of each link plate divides the corresponding link plate into a first link plate section located above and a second link plate section located below the connecting line, where said second link plate section is asymmetric to the first link plate section, at least with respect to the height profile, and wherein the inner link plates are assembled at a 180° rotation.

### CROSS-REFERENCE TO RELATED APPLICATION

This application claims priority to foreign German patent application No. DE 102012001809.6, filed on Jan. 31, 2012, the disclosure of which is incorporated by reference in its entirety.

### FIELD OF THE INVENTION

The invention refers to a toothless link chain with inner and outer chain links alternatingly connected to each other by means of a chain joint, wherein each inner chain link has at least two inner link plates and each outer chain link has at least two outer link plates and two chain joint bolts connecting said chain links, and each chain joint bolt is arranged in a bolt opening of the associated outer chain link in a non-rotating manner, forming a chain joint by projecting through a joint opening of the associated inner chain link, wherein the link plate backs of the inner link plates or the outer link plates, which are brought into contact with a tensioning or guide rail, are configured with an at least partial height offset to the link plate backs of the inner link plates or the outer link plates.

### BACKGROUND

Such a chain is for instance known from GB 2431216 A. This is a timing chain employed in a timing chain drive of a combustion engine. The chain engages two upper camshaft sprockets and one lower crankshaft sprocket. On the pulling side, the outer surface of the chain glides on a gliding rail, and on the loose side, the outer surface of the chain glides on a tensioning rail onto which said outer surface of the chain is pressed by means of a tensioning device. In order to reduce the friction of the chain drive, the outer link plates feature a lower overall height than the height of the inner link plates. Correspondingly, the link plate backs of the inner link plates project further from the centerline than the link plate backs of the outer link plates. As a consequence, only the link plate backs of the inner link plates come into contact with the gliding surface of the respective rail when gliding along the guide and tensioning rail. This reduces the overall friction of the timing chain drive.

Such a friction-reducing technology is also described for toothed chains by DE 102008033900 A1, wherein the link plate backs of certain toothed link plates are increased in height. But the following invention specifically does not refer to such toothed link plates. The invention is also not intended for comparison with dual action toothed chains, wherein chain sprockets can engage into the inner as well as the outer side of the chain. Such dual action toothed chains are not suitable for use in connection with guide or tensioning rails, because these would be immediately destroyed.

### SUMMARY OF THE INVENTION

The purpose of the present invention is to provide a friction-reducing toothless link chain of the initially identified type that provides durability and cost advantages.

For this purpose, a generic toothless link chain is designed in such a way that the inner and outer link plates feature an essentially identical height profile, and that a connecting line projecting through the centerpoints of the bolt openings of each outer link plate and the connecting line projecting through the centerpoints of the joint openings of each inner link plate partitions the corresponding inner or outer link plate into a first link plate section located above the connecting line, and a second link plate section located below the connecting line, where said second link plate section is asymmetrically shaped to the first link plate section, and the inner link plates are assembled at a 180° rotation to the outer link plates around the associated connecting line.

This then constitutes an attempt to closely match the outer contour of the inner and outer link plates, at least with respect to the height profile. This measure preserves the advantage that the height offset is present on one side of the chain as well as the other, permitting reduced friction gliding along a guide or tensioning rail on both sides of the chain, while the inner and outer link plates have nearly the same height profile. Ideally, the outer and inner link plates can have an identical height profile for a significant portion of their length when stacked on top of each other in the unassembled state. An advantageous configuration can also achieve a complete congruency, with the outer and inner link plates having an identical outer contour (circumferential contour). Strength differences can then additionally be compensated by means of different thicknesses of the outer link plates and the inner link plates. In particular, an identical outer contour permits the use of identical stamping tools when producing inner as well as outer link plates. Due to the asymmetrically stamped bolt opening and/or joint opening, the referenced height offset of the link plate backs is attained by correspondingly assembling the link plates at a 180° rotation to each other. The much lower outer link plates used by the state of the art not only require other stamping tools, but also result in other strength and deformation properties, which is accepted in favor of the reduced friction.

The height profile is defined as the height projection above and below the connecting line between the center points of both openings in a link plate. For the purposes of this consideration, the height is measured perpendicularly to the connecting line.

Ideally, a corresponding upper or lower section of the inner and outer link plates can be configured as extending essentially parallel to the gliding surface relative to the associated connecting line for contacting purposes to a tensioning or guide rail. The link plate back that is contacted to a tensioning or guide rail then extends parallel to the associated connecting line, therefore achieving good contact with the running surface on the tensioning or guide rail. Straight link plate backs have proven themselves to be particularly advantageous for such a gliding contact, especially for timing chain drives.

Preferably, the asymmetry can be achieved in that either the corresponding upper or lower side of the inner and/or outer link plates at least on average have a larger distance to the associated connecting line than the respectively other upper or lower side of the same inner and/or outer link plate.

This embodiment is particular advantageous in one version, where the corresponding upper side as well as the corresponding lower side of the inner and/or outer link plate extends parallel to the associated connecting line, and the distance of the upper side and/or the lower side of the associated connecting line ranges between a factor of 1.01 to 1.16, preferably 1.06 to 1.1, of the distance of the connecting line to the respectively other upper and/or lower side of the same link plate. For typically used timing chain sizes, the offset therefore ranges within a few tenth of a millimeter, and is primarily adjusted to the wear characteristics of the rails and chains.

Another, alternative embodiment proposes that one of the corresponding upper sides or lower sides of the inner link plates and/or outer link plates extends at an angle α to the associated connecting line of the respective link plate. This also permits the attainment of a different height profile, even when the largest overall height is identical. In particular, in a certain position, or in at least along a certain area there may be no offset, which then gradually occurs caused by the angle.

Preferably, the angle α can range from 1 to 10°, or be even further limited to a range of 3 to 7°. This relatively small angle range is sufficient to attain the desired height offset, which occurs gradually.

This embodiment can further propose that the vertex of angle α is oriented against the running direction of the link chain. This creates a wedge effect, causing the oil located on the rails and the chain to be forced into this gradually declining gap, and the corresponding link plate to float.

To simplify the assembly of such link plates, a further embodiment proposes to configure each link plate with an irregularity, which is located at the outer contour above or below the connecting line, where said irregularity projects or indents from the outer contour for sorting purposes. In a favorable embodiment, this irregularity can also be identical in all link plates, therefore permitting the use of the same stamping tools. Furthermore, other embodiments of irregularities for outer link plates in relationship to inner link plates are possible. Insofar as different irregularities between outer link plates and inner link plates are employed, these are not regarded in the consideration of the height profile, since these are primarily used for sorting purposes. For this reason, the irregularity is preferably located on the side of the link plates that is not in contact with the rails, or on the receding side.

In a preferred embodiment, the inner chain link has at least two inner link plates and two joint bushings forming the respective joint openings connecting said inner link plates, where said joint bushings are arranged in the corresponding bushing openings of the associated inner link plates in an anti-rotational manner, and through which the respectively associated chain bolts of the associated outer chain link extend. In a preferred manner, exclusively the outer link plates come into contact with the rail(s), whereby a stable operation is achieved in comparison to GB 2431216 due to the distance between the link plate backs.

The invention also refers to a chain drive, specifically a timing chain drive of a combustion engine, having a drive chain sprocket and at least one drive chain sprocket with a toothless link chain wrapped around the chain sprockets, where said toothless link chain is in accordance with one of the preceding embodiments, and at least one tensioning and/or guide rail contacting the link chain.

### BRIEF DESCRIPTION OF THE DRAWINGS

The following provides a more detailed, drawing-based discussion of embodiments of the present invention. It shows:

FIG. 1 a timing chain drive in accordance with the present invention,

FIG. 2 a perspective view of a first embodiment of the toothless link chain according to the invention,

FIG. 3 a side view onto the link chain from FIG. 2,

FIG. 4 a side view onto an inner chain link of the link chain from FIG. 2,

FIG. 5 a side view onto an outer chain link of the link chain from FIG. 2,

FIG. 6 a perspective view of a second embodiment of the toothless link chain according to the invention,

FIG. 7 a side view of the link chain from FIG. 6,

FIG. 8 a side view of an outer chain link of the link chain from FIG. 6 and

FIG. 9 a side view of an inner chain link of the link chain from FIG. 6.

### DETAILED DESCRIPTION

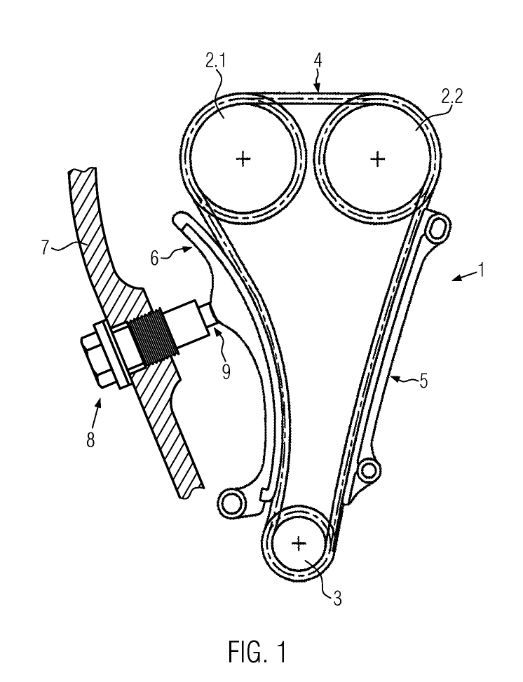

FIG. 1 represents a timing chain drive for a combustion engine. The timing chain drive 1 comprises two upper camshaft sprockets 2.1 and 2.2, one lower crankshaft sprocket 3, a timing chain 4 wrapped around said sprockets, a gliding rail 5 and a pivoting tensioning rail 6 forced onto said timing chain 4 by means of a chain tensioner 8 that is screw-mounted into the motor housing 7. The chain tensioner 8 is preferably connected to the engine hydraulic system, so that its tensioning piston 9 applies hydraulic pressure onto the pivoting tensioning rail 6. The gliding pads of the gliding rail 5 as well as the tensioning rail 6 each contact the outside of the timing chain 4 traveling along these. This creates friction losses that are reduced due to the design of the chain embodiments described below.

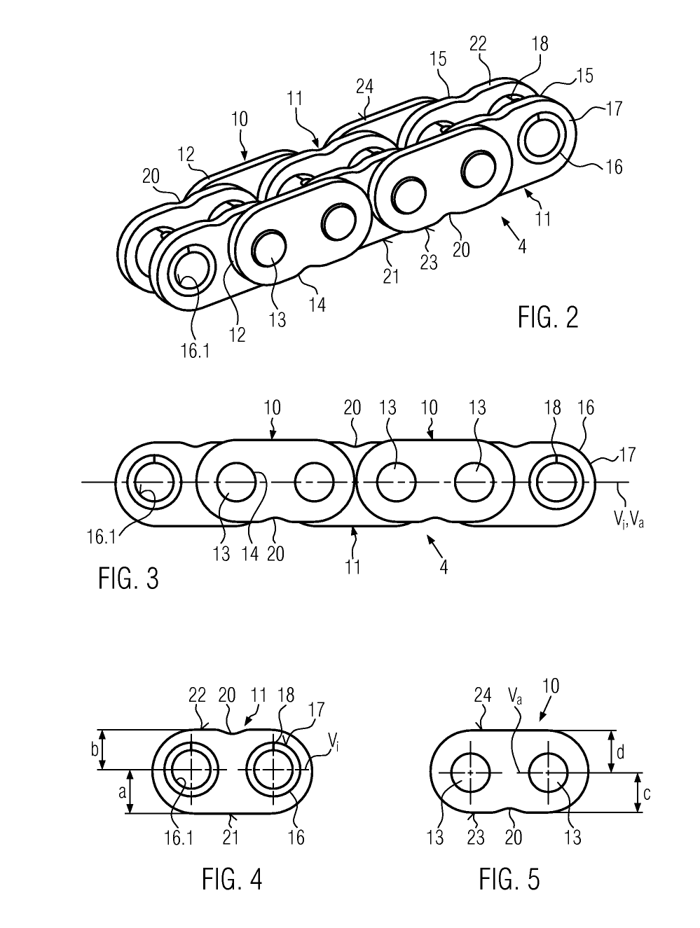

The first embodiment of the timing chain 4 described based on FIGS. 2 to 5 comprises outer chain links 10 and inner chain links 11, alternatingly connected to each other by means of a chain joint. Each outer chain link 10 consists of two outer link plates 12 that are arranged at a distance to each other and two cylindrically shaped chain joint bolts 13 that connect said outer link plates 12 with each other. For this purpose, the chain joint bolts 13 are pressed into the associated bolt openings 14 in the outer link plates 12, so that these protrude slightly. Each inner chain link 11 consists of two inner link plates 15 that are arranged at a distance to each other and connected to each other by means of two joint bushings 16 arranged at a distance to each other. For this purpose, the joint bushings 16 are pressed into corresponding bushing openings 17 of the inner link plates 15. The joint bushings 16 are rolled from a sheet metal strip creating a butt joint 18, the center of which contains a lubricating gap 19. For strength reasons, it can be advantageous to arrange this butt joint 18 at a 90° offset to the orientation shown in drawing 2.

A chain joint bolt 13 of the inner chain link 11 and an associated joint bushing 16 of an inner chain link, through which this chain joint bolt 13 projects, together form a chain link. The inside surface of the joint bushing 16 therefore forms the joint opening 16.1.

In the shown embodiment, the outer contour of the inner link plates 15 and the outer contour of the outer link plates 12 are identical, so that their circumferences are completely congruent when they are stacked on top each other in the correct orientation. Only the thickness of the inner link plates 15 is slightly greater for strength reasons, because the installation of the joint bushing 16 requires a larger bushing opening 17 as compared to the bolt opening 14. Each of the outer link plates 12 and inner link plates 15 have an irregularity along the outer contour in the form of a rounded sorting notch 20. This sorting notch 20 is an assembly aid to install the corresponding link plates 12, 15 in the correct orientation. In the present case, the sorting notch 20 is arranged on one side of the outer contour of the link plates 12, 15 precisely between the respectively associated openings 14 and/or 17. A connecting line Vᵢ (and/or plane) that projects through the center points (and/or center lines) of the bushing openings 17 partitions the respective inner link plate 15 into a link plate section located above the connecting line Vᵢ and a link plate section located below the connecting line Vᵢ, which are asymmetrical to each other (at least with respect to their height profile, respectively measured from the connecting line Vᵢ). This asymmetry is independent of the sorting notch 20, which can be disregarded for the purposes of this consideration. The distance a from the lower section 21 of inner link plate 15 to the connecting line Vᵢ is larger than the distance b from the upper section 22 to the connecting line Vᵢ. In the specific embodiment, the distance a is 5.1 mm and the distance b is 4.7 mm. The distance a is therefore larger than the distance b by a factor of 1.08 (corresponding to a factor range of 1.01 to 1.16, preferably 1.06-1.1).

Since the outer contour of the outer link plates 12 is identical, and these are precisely assembled at a 180° rotation, this relationship is precisely inverted. A connecting line Vₐ (and/or plane) partitions the outer link plate 12 into a link plate section located above the connecting line Vₐ and a link plate section located below the connecting line Vₐ. These two link plate sections are asymmetrically arranged to each other (at least with respect to the height profile). This consideration is also valid independently of the sorting notch 20. The connecting line Vₐ extends through the center points (and/or center lines) of the two bolt openings 14. The distance c to the lower section 23 of the outer link plates 12 is smaller than the distance d from the connecting line Vₐ to the upper section 24 of the outer link plate 12. In the specific case, the distance c is 4.7 mm and the distance d is 5.1 mm. The distance d is therefore larger than the distance c by a factor of 1.08 (corresponding to a factor range of 1.01 to 1.16, preferably 1.06-1.1). When the link plates 12, 15 are assembled in such a manner that their connecting lines Vᵢ and Vₐ are aligned, the figure shows the upper section 24a of outer link plates 12 projecting past the upper section 22 of the inner link plates 15. This is precisely inverted on the opposing side. There, the lower sections 21 of the inner link plates 15 project past the lower sections 23 of the outer link plates 12. This projection, which is strictly mathematically determined to be 0.4 mm for the specific embodiment, causes the chain to only contact the corresponding rail 5, 6 with the outer link plates 12 when gliding on the gliding rail 5 or the tensioning rail 6. The upper section 24 of the outer link plates 12 therefore form the link plate back, which comes into contact with the tensioning and the guide rail 5, 6. The sides having a sorting notch 20 are not designed to come into contact with these rails 5, 6, so that the sorting notches 20 are respectively arranged on the recessed side. Since the lower section 21 of the inner link plates 15 projects past the lower section of the chains as shown in the figures, and these are configured as long straight sections equivalent to the upper sections 24 of the outer link plates 12 (between the center points of the associated openings), this provides a contact surface of the chain with a rail. Moreover, this embodiment also results in the fact that the closing direction of the chain determines whether the inner chain links 11 or the outer chain links 12 come into contact with the rails 5, 6.

The effect of this embodiment consists of reduced friction, since not all link plates come into contact with the rails 5, 6. Furthermore, because the same stamping tool can be used for inner and outer link plates 12,15, such a timing chain 4 can be produced with greater ease and more cost effectively, and because all link plates 12, 15 have the same overall height, no further compensation (except the compensation needed due to the different opening sizes) is required to attain a certain strength in the link plate thickness. Since only the outer link plates 12 come into contact with the rails 5, 6, the chain also has a wide support on the rails 5, 6.

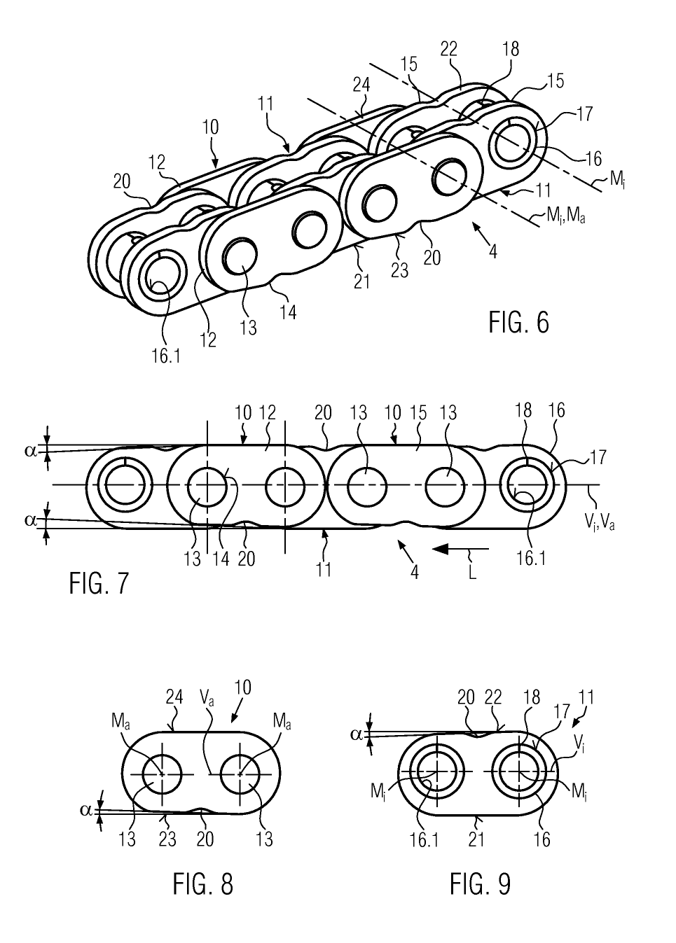

FIGS. 6 to 9 are employed to explain a second embodiment of the present invention as follows. Since the following only details the significant differences from the previously explained embodiment, the same reference numbers are employed to refer to functionally equivalent components from the previous embodiment, and the above description is therefore referenced on a supplementary basis.

The significant difference consists of the outer contour of the inner link plates 15 and the outer link plates 12. Initially, the inner and outer link plates 12, 15 in this embodiment are identical in accordance with FIGS. 6 and 9. Here as well, the inner link plates 15 have a slightly greater thickness. The sorting notch 20 is also arranged in the same location, e.g on the recessed upper section 22 of the inner link plates 15 and the recessed lower section 21 of the outer link plate 12. The upper section 24 of the outer link plate 12 again has a straight link plate back, which comes into contact with the gliding rail 5 and the tensioning rail 6 along its entire surface. In this case, the asymmetry of the outer link plates 12 and the inner link plates 15 is achieved by an oblique section on one of the sides, creating an angle α. In the embodiment shown, the angle α is 5° (and is therefore in the range of 1 to 10°, preferably 3 to 7°). In the present case the lower section 23 of the outer link plate 12 is equipped with the incline at angle α, whereas on the inner link plate 15, the upper section 22 is inclined by the angle α. In the figures, the angle α is shown as originating from a line parallel to the respective connecting line Vᵢ and Vₐ. The outer link plates 12 and inner link plates 15 are assembled in such a manner that the vertex of angle α is oriented against the running direction L. At one point, the upper section 24 of the outer link plates 12 and the associated upper section 22 of the inner link plates 15 are located at the same height, specifically directly above the center point of the rear bushing opening 17 of the inner link plate 15 and the front bolt opening 14 of the outer link plate 12. Originating from this highest point, the height and/or the distance of the upper section 22 to the connecting line Vᵢ is then reduced due to the incline of the angle α.

This is precisely the opposite on the lower section of the chain. In this case, the inner link plates 15 provide a lower section 21 that extends parallel to the respective connecting line Vᵢ, where said lower section 21 comes into contact along its entire surface with a corresponding assembly or when a guide or tensioning rail is correspondingly pressed in, whereas the associated outer link plate 12 is almost entirely recessed due to the incline of the lower section 23 at angle α.

The angle orientation, in particular of the upper section 22 of the inner link plate 15, creates a wedge effect, so that oil, which bonds to the chain 4 and/or the gliding rail 5 or the tensioning rail 6 for lubricating purposes, is forced into this wedge, therefore improving the ability of the timing chain 4 to float. This further enhances the friction-reducing effect.

The projection of the outer chain links 10 compared to the inner chain links 11 on the side contacting the rails 5 and 6 is achieved due to the asymmetric design of the respective link plates with reference to the associated connecting lines Vᵢ and Vₐ. For this purpose, all link plates preferably have the same outer contour; this is however not mandatory as long as this asymmetry results in this projection. Until now, toothless link chains for timing chain drives have always relied on symmetric inner and outer link plates with different overall heights to achieve the same purpose.

1. A toothless link chain comprising:
inner and outer chain links alternately connected to each other by means of a chain joint, wherein each inner chain link has at least two inner link plates and each outer chain link has at least two outer link plates and is equipped with two chain joint bolts connecting said inner and outer chain links to each other, each chain joint bolt is arranged in the associated outer link plates in an anti-rotational manner and projects through a joint opening of the associated inner chain link to form a chain joint, wherein the link plate backs of the inner link plates or the outer link plates, which can be brought into contact by means of a tensioning or gliding rail, at least partially exhibit a height offset to the link plate backs of the outer and/or inner link plates, wherein the inner and outer link plates have a largely identical height profile,
wherein a connecting line through the center points of the bolt openings of each outer link plate, as well as a connecting line through the center points of the joint openings of each inner link plate, dividing the corresponding inner link plate and outer link plate, respectively, into a first link plate section located above the corresponding connecting line and a second link plate section located below the corresponding connecting line, wherein said second link plate section is asymmetric to said first link plate section at least with the respect to the height profile, and the inner link plates are assembled at a 180° rotation to the outer link plates around the associated connecting line.

2. The toothless link chain in accordance with claim 1, wherein a corresponding upper or lower section of the inner link plates and outer link plates is essentially configured as a gliding surface extending parallel to the associated connecting line for purposes of contacting the tensioning or guide rail.

3. The toothless link chain in accordance with claim 1, wherein at least one of the upper section and lower section of the corresponding inner link plate and outer link plate has at least on average a larger distance to the associated connecting line than the respectively other upper section or lower section of the same inner link plate or outer link plate.

4. The toothless link chain in accordance with claim 3, wherein the corresponding upper section and the corresponding lower section of the inner link plate and the outer link plate, respectively, extends parallel to the associated connecting line and the distance of the upper section and the lower section, respectively, to the associated connecting line ranges by a factor of 1.01-1.16 of the distance of the connecting line to the respectively other side of the same link plate.

5. The toothless link chain in accordance with claim 4, wherein the distance of the upper section and the lower section, respectively, to the associated connecting line ranges by a factor of 1.06-1.1 of the distance of the connecting line to the respectively other side of the same link plate.

6. The toothless link chain in accordance with claim 1, wherein a corresponding upper section or lower section of the inner link plate and outer link plate, respectively, extends at an angle to the associated connecting line of the respective link plate.

7. The toothless link chain in accordance with claim 6, wherein the angle ranges from 1 to 10°.

8. The toothless link chain in accordance with claim 7, wherein the angle ranges from 3 to 7°.

9. The toothless link chain in accordance with claim 6, wherein the vertex of angle is oriented against the running direction of the link chain.

10. The toothless link chain in accordance with claim 1, wherein each link plate is equipped with projecting or indenting irregularities along the outer contour correspondingly above or below the connecting line, wherein said irregularities are provided for sorting purposes.

11. The toothless link chain in accordance with claim 1, wherein the inner chain link has at least two inner link plates and two joint bushings forming the respective joint openings that connect said inner link plates to each other, wherein said joint bushings are arranged in the corresponding bushing openings of the associated inner link plates in an anti-rotational manner, and wherein the associated chain joint bolts of the associated outer chain links extend through said joint bushings.

12. A chain drive of a combustion engine, having a drive chain sprocket, at least one driven chain sprocket, a toothless link chain wrapped around the chain sprockets and at least one of a tensioning rail and a gliding rail contacting the link chain;
the toothless link chain having inner and outer chain links alternately connected to each other by means of a chain joint, wherein each inner chain link has at least two inner link plates and each outer chain link has at least two outer link plates and is equipped with two chain joint bolts connecting said inner and outer chain links to each other, each chain joint bolt is arranged in the associated outer link plates in an anti-rotational manner and projects through a joint opening of the associated inner chain link to form a chain joint, wherein the link plate backs of the inner link plates or the outer link plates, which can be brought into contact by means of a tensioning or gliding rail, at least partially exhibit a height offset to the link plate backs of the outer and/or inner link plates,
wherein the inner and outer link plates have a largely identical height profile, wherein a connecting line through the center points of the bolt openings of each outer link plate, as well as a connecting line through the center points of the joint openings of each inner link plate, dividing the corresponding inner link plate and outer link plate, respectively, into a first link plate section located above the corresponding connecting line and a second link plate section located below the corresponding connecting line, wherein said second link plate section is asymmetric to said first link plate section at least with the respect to the height profile, and the inner link plates are assembled at a 180° rotation to the outer link plates around the associated connecting line.

13. The chain drive of a combustion engine in accordance with claim 12, wherein the chain drive is a timing chain drive.
